(19) United States
(12) Patent Application Publication
(10) Pub. No.: US 2008/0312124 A1
(43) Pub. Date: Dec. 18, 2008

(54) Chelate Compound-Containing Composition and Use as Detergents Thereof

(75) Inventor: Tomomi Ina, Osaka-shi (JP)

Correspondence Address: CONNOLLY BOVE LODGE & HUTZ LLP, 1875 EYE STREET, N.W., SUITE 1100, WASHINGTON, DC, 20006, US

(73) Assignee: NIPPON SHOKUBAI CO., LTD, Osaka-shi, Osaka (JP)

(21) Appl. No.: 11/569,817

(22) PCT Filed: May 30, 2005
(86) PCT No.: PCT/JP2005/010280

§ 371 Date: Aug. 25, 2008

(30) Foreign Application Priority Data
May 31, 2004 (JP) 2004-161650
Sep. 3, 2004 (JP) 2004-257521

(51) Int. Cl. C11D 3/33

(52) U.S. Cl. 510/480

(57) ABSTRACT

The present invention provides to chelate compound-containing composition with a high concentration which is excellent in stability in high concentration alkaline condition, stable even in a long-term storage, has improved transportation efficiency, and advantageous for preservation, and a method for using a chelate compound-containing composition with a high concentration which is improved in washing capability and can exhibit a low corrosive property to glass. A high concentrated chelate compound-containing composition containing an alkaline compound and a chelate compound, wherein the chelate compound comprises a compound represented by the following formula (1);

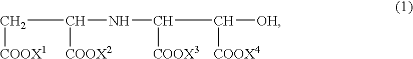

in the formula, X¹ to X⁴ may be the same or different and each represents a hydrogen atom, an alkali metal atom or an ammonium group, the content of the chelate compound is 1 to 90% by weight and the content of the alkaline compound is 10 to 85% by weight, and a use as a detergent of the chelate compound-containing composition.

### TECHNICAL FIELD

The present invention relates to a chelate compound-containing composition and its use as detergents. More particularly, the present invention relates to a chelate compound-containing composition useful for organic chelating agents, scale preventing agents, water treatment agents, builders for detergents, bleaching assisting agents, masking agents, fiber treatment agents, additives for paper and pulp, detergents for semiconductors, photographic chemical agents, and soil modifiers as well as a chelate compound-containing composition useful for washing in a variety of fields such as food industries, chemical industries, and machinery industries and also washing for domestic or industrial automatic dishwashers and its use as detergents.

### BACKGROUND ART

Since a chelate compound-containing composition can form a complex with various kinds of metal ions, the composition is used preferably for various uses of organic chelating agents, scale preventing agents, water treatment agents, builders for detergents, bleaching assisting agents, masking agents, fiber treatment agents, additives for paper and pulp, detergents for semiconductors, photographic chemical agents, and soil modifiers. As such compositions, a solution containing a chelating compound dissolved in aqueous alkaline solutions may be exemplified. In terms of convenience for transportation and storage, the solution is desired to have high concentrated chelate compound-containing composition stably dissolved in a high concentration alkaline solution.

With respect to a conventional aqueous composition containing a chelate compound, a composition containing an iminocarboxylic acid salt having a specified structure in which the isomer ratio (D isomer/L isomer (mole ratio)) of the aspartic acid skeleton part is in a range of 1/0 to 0.7/0.3 or in a range of 0/1 to 0.3/0.7 and content of the iminocarboxylic acid salt is 40 to 70% by weight is disclosed (e.g., reference to Japanese Patent No. 2644977, p. 1 to 2). In such an aqueous composition, there is no description of dissolution of an iminocarboxylic acid salt in a high concentration alkaline solution. Also, with respect to a detergent composition, it is disclosed that a composition containing an alkali metal hydroxide and a disuccinic acid compound with a specified structure and that the compound is used for washing a hard surface (e.g., reference to Japanese Kokai Publication Hei-11-302691, p. 2). In the detergent composition, there is a description that the concentration of the alkali compound is preferably 2 to 10% by weight and the concentration of the chelate compound is preferably 0.05 to 10% by weight, and a solution containing 2 to 3% of sodium hydroxide and approximately 0.4% of chelate compound is also described in Example. Such a composition is insufficient in the alkali concentration and chelate compound concentration and so far any composition with further increased concentration has not been disclosed.

With respect to a detergent composition for automatic dishwashers, disclosed is a composition containing 20 to 70% of an alkaline salt and 1 to 30% of glutamic acid diacetic acid or its salt having a specified structure as essential components and having pH value 9 or higher in 1 weight % of an aqueous solution (e.g., reference to Japanese Kokai Publication 2000-63894, p. 2 and 4). There is a description that with respect to a liquid composition containing NaOH and glutamic acid-N,N-diacetic acid (GLDA), when 35% or more of GLDA is contained, preparation of a stable composition is difficult.

When the chelate compound is dissolved in an aqueous solution of high concentration alkaline with a high concentration, the chelate compound contained in such a composition is precipitated or the aqueous solution becomes in a layered state and therefore, there was a room for contrivance to provide a chelate compound with improved solubility, improved stability and improved washing capability and glass corrosive property.

### SUMMARY OF THE INVENTION

In view of the above-mentioned state of the art, it is an object of the present invention to provide a chelate compound-containing composition with a high concentration which is excellent in stability in high concentration alkaline condition, stable even in a long-term storage, has improved transportation efficiency, and advantageous for preservation, and a method for using a chelate compound-containing composition with a high concentration which is improved in washing capability and can exhibit a low corrosive property to glass.

The present inventor made various investigations concerning a composition obtained by dissolving a chelate compound in an aqueous solution of alkaline and consequently have found that 3-hydroxy-2,2′-iminodisuccinic acid (HIDS) has a high solubility in an aqueous solution of alkaline and give a stable and high concentration composition containing the chelate compound. The present inventor thus has found that when the alkaline compound concentration and the dissolution concentration of HIDS are specified in the composition, not only the excellent stability of the composition is maintained but also the transportability and the storability may be advantageous and that the composition is advantageously usable for various uses of organic chelating agents, scale preventing agents, water treatment agents, builders for detergents, bleaching assisting agents, masking agents, fiber treatment agents, additives for paper and pulp, detergents for semiconductors, photographic chemical agents, and soil modifiers and have come to a solution of the above-mentioned problems. Furthermore, the present inventor has found that when the concentrations of an alkaline compound and HIDS are specified in the composition for washing, in addition to the above-mentioned effects, the composition is improved in the washing capability and has suppressed corrosive property to glass. These findings have now led to completion of the present invention.

That is, the present invention provides a high concentrated chelate compound-containing composition containing an alkaline compound and a chelate compound,

wherein the chelate compound comprises a compound represented by the following formula (1);

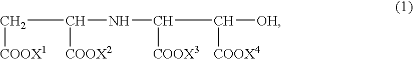

in the formula, X¹ to X⁴ may be the same or different and each represents a hydrogen atom, an alkali metal atom or an ammonium group,
the content of the chelate compound is 1 to 90% by weight and the content of the alkaline compound is 10 to 85% by weight.

The present invention further provides use as a detergent of the chelate compound-containing composition.

### DETAILED DESCRIPTION OF THE INVENTION

Hereinafter, the present invention will be described in more detail.

A chelate compound-containing composition of the present invention contains a chelate compound essentially containing a chelate compound represented by the above-mentioned formula (1) and an alkaline compound.

The content of the chelate compound is preferably 1 to 90% by weight in 100% by weight (mass % or % by mass) of the chelate compound-containing composition. When the content is less than 1% by weight, the composition might be insufficient for advantageous use in the transportation or storage or might be insufficiently improved in the washing capability in the case of use as detergents. The lower limit is preferably 1% by weight, more preferably 2% by weight, furthermore preferably 15% by weight, even more preferably 20% by weight, and most preferably 25% by weight. On the other hand, when it exceeds 90% by weight, the stability as the composition may be insufficiently improved. The range of the content of the above-mentioned chelate compound is more preferably 15 to 90% by weight.

The chelate compound essentially contains the compound represented by the above-mentioned formula (1). In the X¹ to X⁴, the alkali metal atom is preferably lithium, sodium, potassium, rubidium, cesium and the like, for example. The X¹ to X⁴ is preferably sodium or potassium.

The content of the alkaline compound is preferably 10 to 85% by weight in 100% by weight of the chelate compound-containing composition. When the content is less than 10% by weight, the composition might be insufficient for advantageous use in the transportation or storage. The lower limit value is preferably 15% by weight. When it exceeds 85% by weight, the stability as the composition may be insufficiently improved. The upper limit is more preferably 80% by weight.

Preferable examples of the above-mentioned alkaline compound are alkali (alkaline earth) metal hydroxides such as sodium hydroxide, potassium hydroxide, and lithium hydroxide; alkali (alkaline earth) metal carbonates such as sodium carbonate, sodium hydrogen carbonate (sodium dicarbonate), and potassium carbonate; alkali (alkaline earth) metal silicates such as sodium orthosilicate, potassium orthosilicate, sodium metasilicate, potassium metasilicate, sodium sesquisilicate, and potassium sesquisilicate; ethanolamines such as monoethanolamine, and diethanolamine. Among them are preferable potassium hydroxide and sodium hydroxide.

The chelate compound of the present invention essentially contains a compound represented by the above-mentioned formula (1). In the structure of such a compound, there are L-isomer and D-isomer of aspartic acid skeleton part. The aspartic acid skeleton part of the compound represented by the above-mentioned formula (1) means the structure represented by the following formula (3) in the formula (1):

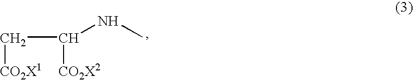

in the formula, X¹ and X² may be the same or different and each represents that in the formula (1).

The L-isomer and D-isomer of aspartic acid skeleton part are compounds having S arrangement and R arrangement in the configuration of an asymmetric carbon atom in the structure represented by the formula (3) and the compound having the S arrangement corresponds to the L isomer, and the compound having the R arrangement corresponds to the D isomer.

Examples of methods for preparing the compound represented by the above-mentioned formula (1) include a method of reacting an aspartic acid and/or its salt with an epoxysuccinic acid in a water-based medium.

In the above-mentioned preparation method, the ratio of the aspartic acid and/or its salt to an epoxysuccinic acid in raw materials and the reaction conditions such as reaction temperature are not particularly limited. Also, as the epoxysuccinic acid, both cis- and trans-isomers may be used and cis-isomer may be preferably used. The water-based medium means water or mixtures of water and solvents soluble in water. Preferable examples are water and solvent mixtures of methanol, ethanol, isopropyl alcohol, acetone, and acetonitrile with water and the like. Among them, water is preferably used.

In the above-mentioned reaction, for example, when D-aspartic acid and/or its salt is used as a raw material, the configuration derived from the D-aspartic acid is retained in R-arrangement at the asymmetric carbon atom of the aspartic acid skeleton part in the structural formula of the produced compound represented by the formula (1). Accordingly the compound represented by the formula (1) in which the aspartic acid skeleton part forms D-isomer may be produced. Such compound represented by the formula (1) can be prepared by producing an aqueous solution containing the compound represented by the formula (1) by adding epoxysuccinic acid to the reaction solution containing aspartic acid whose carboxylic acid is partially or entirely neutralized and reacting aspartic acid with epoxysuccinic acid.

The compound represented by the above-mentioned formula (1) may include optical isomers, but the contents of the respective optical isomers are not particularly limited and L-isomer or D-isomer may be used alone by synthesizing L-isomer or D-isomer or resolving racemic modifications. The biodegradability of HIDS differs among isomers and increases in order of D-isomer, racemic modification, and L-isomer, and therefore, racemic modification may be preferably used and L-isomer may be more preferably used as HIDS. As a method of adjusting the isomer ratio in the above-mentioned aspartic acid skeleton part of the compound represented by the formula (1) to a specified range, preferred are a method of carrying out reaction using raw materials containing aspartic acid and/or its salt with D-isomer and L-isomer having the ratio of a specified range and a method of separately synthesizing D-isomer of the compound represented by the formula (1) and L-isomer of the compound represented by the formula (1) and mixing them at a specified ratio.

The chelate compound in the present invention essentially contains the compound represented by the above-mentioned formula (1). Such a chelate compound may contain a compound in which X¹ to X⁴ represented by the above-mentioned formula (1) may be same or different and each X¹ to X⁴ may contain hydrogen atom, alkali metal atom, ammonium group, alkaline earth metal atom, or organic ammonium group.

Examples of the above-mentioned alkali metal atom are those mentioned above, and examples of the alkaline earth metal atom are magnesium, calcium, strontium, and barium, and examples of organic ammonium group (organic amine group) are alkylamine group such as monoethylamine group, diethylamine group and triethylamine group; alkanolamine group such as monoethanolamine group, diethanolamine group and triethanolamine group; polyamine group such as ethylenediamine group and triethylenediamine group.

With respect to the above-mentioned chelate compound, other chelate compounds may be added unless the effects of the chelate compound-containing composition of the present invention are sacrificed.

The above-mentioned chelate compound-containing composition is produced by mixing the above-mentioned chelate compound, an alkaline compound, and, as necessary, other compounds. These compounds to be mixed may be used in any state such as powders, slurries, or solutions. In the case that the composition of the present invention is in a liquid state, examples of preferable mixing states include a state that an aqueous solution of alkaline compound and an aqueous solution of chelate compound are mixed or a state that a solid-state chelate compound is added to and mixed with an aqueous solution of alkaline compound. In the case that the composition is in a solid state, preferred are a state that a powder of a chelate compound and a solid-state alkaline compound are mixed or a state that a solid-state alkaline compound is added to and kneaded with an aqueous solution of chelate compound.

The state of the chelate compound-containing composition of the present invention is not particularly limited as long as the effect of the present invention is exhibited and any state such as a powder, slurry, a solution, or a solid may be used. Among them, the above-mentioned chelate compound-containing composition is preferably in a liquid state.

In the case that the above-mentioned chelate compound-containing composition is in a liquid state, it is preferable that the concentration of the chelate compound is 1 to 50% by weight in any concentrations of 10 to 45% by weight of the alkaline compound. Accordingly, the stability as the composition may be maintained even in a high alkaline solution, and the composition may be not only advantageous in the transportation and storage but also exhibit improved excellent washing capability and suppressed corrosive property in the case of use as a detergent, for example. That is, it is also one of the preferable embodiments of the present invention that the chelate compound-containing composition, wherein the chelate compound-containing composition is an aqueous solution, the content of the chelate compound is 1 to 50% by weight and the content of the alkaline compound is 10 to 45% by weight.

The state that the chelate compound-containing composition is stable means that no precipitate is practically formed in the case the composition is left at 40° C. for 1 month.

With respect to the concentration of the chelate compound, when it is lower than 1% by weight in 100% by weight of the chelate compound-containing composition, the composition is insufficiently advantageous in the transportation and storage or insufficiently improved in the washing capability in the case of use as detergents. The lower limit is preferably 2% by weight, more preferably 15% by weight, and even more preferably 20% by weight. When it exceeds 50% by weight, the stability as the composition is not sufficiently improved. The upper limit is preferably 45% by weight and more preferably 40% by weight. The range of the content of the chelate compound is more preferably 15 to 50% by weight.

With respect to the concentration of the alkaline compound, when it is lower than 10% by weight in 100% by weight of the chelate compound-containing composition, the composition is insufficiently advantageous in the transportation and storage. The lower limit is preferably 15% by weight and more preferably 20% by weight. When it exceeds 45% by weight, the stability of the composition may be insufficiently improved. The upper limit is preferably 40% by weight and more preferably 35% by weight.

The chelate compound and the alkaline compound are the same as those mentioned above.

The chelate compound-containing composition of the present invention contains the chelate compound and the alkaline compound of specified ranges. As the alkaline compound, potassium hydroxide and sodium hydroxide are preferable and sodium hydroxide is more preferable. It is also one of the preferable embodiments of the present invention that the chelate compound-containing composition, wherein the chelate compound is a compound represented by the following formula (2);

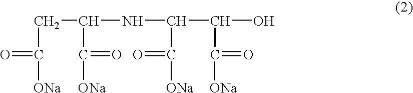

and the alkaline compound comprises sodium hydroxide.

The chelate compound-containing composition containing potassium hydroxide or sodium hydroxide as the above-mentioned alkaline compound exhibits sufficient washing capability in either case. The chelate compound-containing composition containing potassium hydroxide can form not only the compound represented by the formula (1) but also the stable compound with the general chelate compound easily, and thus the composition containing potassium hydroxide is preferably used in the present invention. On the other hand, the chelate compound-containing composition containing sodium compound may be preferably used since the compound represented by the formula (1) has wider stable range of the compound as compared with that of the conventional chelate compound. Furthermore, sodium hydroxide is more economical as compared with other alkaline compounds such as potassium hydroxide, leading to advantage in cost problem.

As described above, it is also one of the preferable embodiments of the present invention that the stabilized high concentrated chelate compound-containing composition containing sodium hydroxide and a chelate compound, wherein the composition is an aqueous solution and the chelate compound comprises a compound represented by the above-mentioned formula (1), the content of the chelate compound is 15 to 50% by weight and the content of the sodium hydroxide is of 10 to 45% by weight.

The above-mentioned chelate compound-containing composition may be produced by mixing the above-mentioned chelate compound, sodium hydroxide, and, as necessary, other compounds. These compounds may be used in any state such as powders, slurries, or solutions. Examples of preferable mixing states include a state that an aqueous solution of sodium hydroxide and an aqueous solution of chelate compound are mixed, a state that a chelate compound in form of a powder is added to and mixed with an aqueous solution of sodium hydroxide, or a state that sodium hydroxide in solid or melted state and an aqueous solution of chelate compound are added to water and mixed.

The present invention also provides use as a detergent of the chelate compound-containing composition.

In the case that the above-mentioned chelate compound-containing composition is used as a detergent, the composition may be used as it is depending on uses or may be diluted in a proper concentration with diluents and the like depending on the intended uses. The composition is preferably useful for washing in various food production apparatuses (facilities for food and beverages, tanks and pipelines in food processing plants), various kinds of bottles such as beer bottles and milk bottles and for washing by automatic dishwashers. In such uses, washing is carried out by jetting an alkaline washing solution. Conventionally, at the time of washing, owing to a trace amount of silicate eluted by the detergent, insoluble silicate scales are formed on the surface of glass and earthen ware to results in white stain adhesion, fogging, and luster deterioration. Use of the chelate compound-containing composition of the present invention or its diluted solution may exhibit effect that fogging and luster deterioration caused by such white stain adhesion are suppressed because of lower glass corrosive property as compared with that in EDTA solution (an ethylenediaminetetraacetic acid solution).

Furthermore, the chelate compound-containing composition of the present invention or its diluted solution has excellent solubility for a water-insoluble calcium salt, it may be preferably used for washing facilities and containers in which insoluble calcium salts are produced during the use. As such facilities and containers, brewing tanks may be exemplified. Conventionally, in the brewing tanks such as beer tanks, insoluble calcium salts containing mainly calcium oxalate are produced and in the case of wine production, white crystal of calcium tartrate is formed in the bottoms of tanks or bottles with aging of wine. The chelate compound-containing composition of the present invention or its diluted solution can efficiently dissolve these insoluble calcium salts. For example, the composition can dissolve calcium oxalate with similar capability to that of an EDTA solution and accordingly it can be advantageously used as a scale-dissolving agent. Also, the chelate compound-containing composition of the present invention or its diluted solution has remarkably high calcium tartrate solubility as compared with that of EDTA, and therefore it can be used for washing brewing tanks such as wine tanks.

The above-exemplified compounds are preferably used as the chelate compound and the alkaline compound in the case that the chelate compound-containing composition of the present invention is used as a detergent. Furthermore, the contents of these compounds are as described above and can properly be set depending on the uses such as detergents for washing beer tanks (CIP washing), liquid type detergents for dishwashers, and solid type detergents for dishwashers.

As mentioned above, the chelate compound-containing composition of the present invention is preferably used for washing. Another preferable embodiment of the present invention is that a high concentrated chelate compound-containing composition for washing containing an alkaline compound and a chelate compound, wherein the chelate compound comprises a compound represented by the above-mentioned formula (1), the content of the chelate compound is 15 to 90% by weight and the content of the alkaline compound is 10 to 85% by weight.

In addition to the above-mentioned compounds, the chelate compound-containing composition may further contain inorganic builders, dispersants, surfactants, defoaming agents, scale-forming preventing agents, granulating agents, fillers, breaching agents, breaching activation agents, surface modifying agents, corrosion preventing agents, re-staining preventing agents, fluorescent brighteners, disinfectants, enzymes, fragrances, coloring agents, saccharides or saccharide acids, or their salts.

Preferable examples of the inorganic builders may include anhydrous sodium sulfate and anhydrous potassium sulfate. Preferable examples of the dispersants are carboxylic acid salt polymers such as a polyacrylic acid sodium salt and acrylic acid-maleic acid copolymer sodium salt. Preferable examples of the surfactants are high foaming surfactants such as alkylsulfate salts, α-sulfofatty acid salts, soap, alcohol ethoxylates, alkyl polyglycosides, and low foaming nonionic surfactants such as ethylene oxide-propylene oxide copolymers. Preferable examples of the defoaming agents are silicone type defoaming agents, fatty acid type defoaming agents, and fatty acid ester type defoaming agents. Preferable examples of the scale-forming preventing agents are hexametaphosphoric acid and its alkali metal salts. Preferable examples of the granulating agents are sodium sulfate and amorphous silica and the like. Preferable examples of the fillers are sodium sulfate, potassium sulfate, sodium chloride, and potassium chloride.

The chelate compound-containing composition of the present invention may be used for a variety of uses, for example, as organic chelating agents, scale preventing agents, water treatment agents, builders for detergents, bleaching assisting agents, masking agents, fiber treatment agents, additives for paper and pulp, detergents for semiconductors, photographic chemical agents, and soil modifiers. The chelate compound-containing composition of the present invention may be preferably used for washing in various manners for washing out and removing stains adhering to hard surfaces of glass, plastics, and metals. As washing methods, immersion washing, jet washing, circulation washing, brush washing, and spray washing methods may be employed.

In the case of using the composition of the present invention for washing, depending on the uses, it may be used as it is or may be diluted in a proper concentration with a proper diluent. The composition is preferably used for washing containers for filling beverages such as beer and juice and food products such as processed foods in food industries and chemical industries; containers for housing these containers; tanks such as fermentation tanks for beer; apparatuses such as pipelines of apparatuses for production of foods, disinfection plates, and filling machines; work fields; and transportation vehicles such as tank vehicles and container vehicles.

Also, the composition may be used for washing by domestic or industrial automatic dishwashers, metal surface washing, metal cleaning, and precision washing in chemical and mechanical industries.

The chelate compound-containing composition of the present invention is constituted as described above and is excellent stability in high concentration of alkaline conditions and stable even in long-term storage, and has improved transportation efficiency and advantageous in preservation. Furthermore, since the chelate compound-containing composition has improved washing capability and suppressed corrosive property to glass or the like as well as the above-mentioned effects, it may be used for a variety of uses for washing.

### BEST MODE FOR CARRYING OUT THE INVENTION

Hereinafter, the present invention will be described in more detail with reference to Examples, but it is not intended that the present invention be limited to the following embodiments. In addition, “part” represents “part by weight” and “%” represents “% by weight” as particular notice is not given.

### Examples 1 to 6

An alkaline compound, 3-hydroxy-2,2′-iminodisuccinic acid tetrasodium salt (HIDS.4Na), and ion-exchanged water were mixed in the concentrations respectively shown in Table 1 to produce chelate compound-containing compositions. The solution state containing the produced chelate compound-containing compositions after 1 month of storage at 40° C. is shown in Table 1.

### Comparative Examples 1 to 7

Using an alkaline compound shown in Table 1, chelate compound-containing compositions were produced by changing HIDS.4Na to ethylenediamine tetraacetic acid tetrasodium salt (EDTA.4Na) or nitrilotriacetic acid trisodium salt (NTA.3Na) and mixing as shown in Table 1. The solution state containing the produced chelate compound-containing compositions after 1 month of storage at 40° C. is shown in Table 1.

TABLE 1

| | | | Concentration | Concentration | |
|---|---|---|---|---|---|
| | Chelate | Alkaline | of chelate | of alkaline | |
| | compound | compound | compound(%) | compound(%) | Solution state |
| Example 1 | HIDS•4Na | NaOH | 15 | 40 | Colorless and |
| | | | | | transparent |
| Example 2 | HIDS•4Na | NaOH | 25 | 25 | Colorless and |
| | | | | | transparent |
| Example 3 | HIDS•4Na | NaOH | 45 | 10 | Colorless and |
| | | | | | transparent |
| Example 4 | HIDS•4Na | NaOH | 2 | 40 | Colorless and |
| | | | | | transparent |
| Example 5 | HlDS•4Na | KOH | 15 | 40 | Colorless and |
| | | | | | transparent |
| Example 6 | HIDS•4Na | KOH | 45 | 10 | Colorless and |
| | | | | | transparent |
| Comparative | EDTA•4Na | NaOH | 15 | 40 | White |
| Example 1 | | | | | preticipation |
| Comparative | EDTA•4Na | NaOH | 45 | 10 | White |
| Example 2 | | | | | preticipation |
| Comparative | EDTA•4Na | NaOH | 2 | 40 | White |
| Example 3 | | | | | preticipation |
| Comparative | NTA•3Na | NaOH | 15 | 40 | White |
| Example 4 | | | | | preticipation |
| Comparative | NTA•3Na | NaOH | 45 | 10 | White |
| Example 5 | | | | | preticipation |
| Comparative | NTA•3Na | NaOH | 2 | 40 | White |
| Example 6 | | | | | preticipation |
| Comparative | EDTA•4Na | KOH | 15 | 40 | White |
| Example 7 | | | | | preticipation |

### Examples 7 and Comparative Examples 8 to 10

Chelate compounds, NaOH, and ion-exchanged water were mixed and adjusted so as to be in concentrations as shown in Table 2 to produce test solutions. The chelate compounds were properly selected and used from 3-hydroxy-2,2′-iminodisuccinic acid tetrasodium salt (HIDS.4Na), ethylenediamine tetraacetic acid tetrasodium salt (EDTA.4Na), or nitrilotriacetic acid trisodium salt (NTA.3Na). Slide glasses as test specimens were hung and immersed in the test solutions at 40° C. for 2 weeks. After the immersion, the test specimens were washed with ion-exchanged water and measured for the weights and the surface areas to calculate the corrosive degree (mg/cm²/day) according to the following formula (1)

$$Corrosive degree = \frac{\begin{matrix}Weight of test specimen before the immersion - \\ Weight of test specimen after the immmersion ( mg )\end{matrix}}{\begin{matrix}Surface area of test specimen ( {cm}^{2} ) \times \\ Immersion period ( day )\end{matrix}} \qquad ( formula 1 )$$

TABLE 2

| | | | | Corrosive |
|---|---|---|---|---|
| | | | Concentration | degree |
| | Concentration | Chelate | of chelate | (mg/cm²/ |
| | of NaOH(%) | compound | compound(%) | day) |
| Example 7 | 10 | HIDS•4Na | 3 | 0.025 |
| Compara- | 10 | None | — | 0.025 |
| teive | | | | |
| Example 8 | | | | |
| Compara- | 10 | EDTA•4Na | 3 | 0.052 |
| teive | | | | |
| Example 9 | | | | |
| Compara- | 10 | NTA•3Na | 3 | 0.068 |
| teive | | | | |
| Example 10 | | | | |

### Evaluation Examples 1 to 4

The test solutions were produced by the same manner as in Example 7 and Comparative Examples 8 to 10 except that the chelate compound, NaOH, and ion-exchanged water were mixed and adjusted so as to be in concentrations as shown in Table 3.

TABLE 3

| | | | | Corrosive |
|---|---|---|---|---|
| | | | Concentration | degree |
| | Concentration | Chelate | of chelate | (mg/cm²/ |
| | of NaOH(%) | compound | compound(%) | day) |
| Evaluation | 5 | HIDS•4Na | 3 | 0.051 |
| Example 1 | | | | |
| Evaluation | 5 | None | — | 0.020 |
| Example 2 | | | | |
| Evaluation | 5 | EDTA•4Na | 3 | 0.084 |
| Example 3 | | | | |
| Evaluation | 5 | NTA•3Na | 3 | 0.069 |
| Example 4 | | | | |

### Example 8 and Comparative Examples 11 to 13

Chelate compounds, NaOH, and ion-exchanged water were mixed and adjusted so as to be in concentrations as shown in Table 3 to produce test solutions. The chelate compounds were properly selected and used from 3-hydroxy-2,2′-iminodisuccinic acid tetrasodium salt (HIDS-4Na), ethylenediamine tetraacetic acid tetrasodium salt (EDTA.4Na), or nitrilotriacetic acid trisodium salt (NTA.3Na). Slide glasses as test specimens were hung and immersed in the test solutions at 100° C. for 3 days. After the immersion, the test specimens were washed with ion-exchanged water and measured for the weights and the surface areas to calculate the corrosive degree (mg/cm²/day) according to the above-mentioned formula (1)

TABLE 4

| | | | | Corrosive |
|---|---|---|---|---|
| | | | Concentration | degree |
| | Concentration | Chelate | of chelate | (mg/cm²/ |
| | of NaOH(%) | compound | compound(%) | day) |
| Example 8 | 10 | HIDS•4Na | 3 | 5.7 |
| Comparative | 10 | None | — | 8.0 |
| Example 11 | | | | |
| Comparative | 10 | EDTA•4Na | 3 | 9.9 |
| Example 12 | | | | |
| Comparative | 10 | NTA•3Na | 3 | 6.4 |
| Example 13 | | | | |

As is clear from Table 2 to Table 4, the compositions containing HIDS have lower glass corrosive property as compared with the comparative compositions containing EDTA or NTA.

### Evaluation Examples 5 to 8

Water-insoluble calcium salts 0.6%, chelate compounds 0.2%, NaOH 3%, and ion-exchanged water as the rest were mixed to produce test solutions. As the water-insoluble calcium salts, calcium tartrate or calcium oxalate were used and as the chelate compounds, (HIDS.4Na) or (EDTA.4Na) was selected and used as shown in Table 4. After the test solutions were stirred at 80° C. for 1 hour, dissolved Ca²⁺ was quantitatively analyzed by ICP emission spectrophotometer and converted into calcium salt weight to calculate the calcium salt solubility according to the formula (2).

Calcium salt solubility(%)(weight of dissolved calcium salt/weight of the added calcium salt)×100 (Formula 2)

TABLE 5

| | Chelate | | |
|---|---|---|---|
| | compound | Calcium salt | Calcium salt solubility (%) |
| Evaluation | HIDS•4Na | Calcium tartrate | 72 |
| Example 5 | | | |
| Evaluation | HIDS•4Na | Calcium oxalate | 13 |
| Example 6 | | | |
| Evaluation | EDTA•4Na | Calcium tartrate | 44 |
| Example 7 | | | |
| Evaluation | EDTA•4Na | Calcium oxalate | 13 |
| Example 8 | | | |

As is clear from Table 5, the compositions containing HIDS has the solubility of insoluble calcium salts equal to or higher than that of the comparative compositions containing EDTA.

The present application claims priority under 35 U.S.C. §119 to Japanese Patent Application No. 2004-161650 filed May 31, 2004, entitled “CHELATE COMPOUND-CONTAINING COMPOSITION AND USE AS DETERGENTS THEREOF” and Japanese Patent Application No. 2004-257521 filed Sep. 3, 2004, entitled “CHELATE COMPOUND-CONTAINING COMPOSITION AND USE AS DETERGENTS T0 2 0 HEREOF.” The contents of these applications are incorporated herein by reference in their entirely.

1. A high concentrated chelate compound-containing composition containing an alkaline compound and a chelate compound,
wherein the chelate compound comprises a compound represented by the following formula (1); 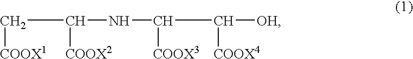
in the formula, X¹ to X⁴ may be the same or different and each represents a hydrogen atom, an alkali metal atom or an ammonium group,
the content of the chelate compound is 1 to 90% by weight and the content of the alkaline compound is 10 to 85% by weight.

2. The chelate compound-containing composition according to claim 1,
wherein the content of the chelate compound is 15 to 90% by weight.

3. The chelate compound-containing composition according to claim 1,
wherein the chelate compound-containing composition is an aqueous solution, the content of the chelate compound is 1 to 50% by weight and the content of the alkaline compound is 10 to 45% by weight.

4. The chelate compound-containing composition according to claim 3,
wherein the content of the chelate compound is 15 to 50% by weight.

5. The chelate compound-containing composition according to claim 1,
wherein the chelate compound is a compound represented by the following formula (2); 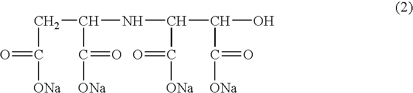
and the alkaline compound comprises sodium hydroxide.

6. Use as a detergent of the chelate compound-containing composition according to claim 1.

7. Use as a detergent of the chelate compound-containing composition according to claim 2.

8. Use as a detergent of the chelate compound-containing composition according to claim 3.

9. Use as a detergent of the chelate compound-containing composition according to claim 4.

10. Use as a detergent of the chelate compound-containing composition according to claim 5.
